(19) United States
(12) Patent Application Publication
(10) Pub. No.: US 2024/0231122 A9
(43) Pub. Date: Jul. 11, 2024

(54) Detachable Three-Piece Eyeglasses Suitable for Single Eyewear

(71) Applicant: Anjuli Jadwani, Brossard (CA)

(72) Inventor: Anjuli Jadwani, Brossard (CA)

(73) Assignee: AJsens Inc., Brossard, QC (CA)

(21) Appl. No.: 18/490,712

(22) Filed: Oct. 19, 2023

Related U.S. Application Data
(60) Provisional application No. 63/380,191, filed on Oct. 19, 2022.

(51) Int. Cl. G02C 5/00

(52) U.S. Cl. CPC G02C 5/006; G02C 2200/02

(57) ABSTRACT

The present invention provides a detachable three-piece eyeglass frame comprising:
a left-side frame component comprising a left temple arm, a left temple tip, and a left eye glass rim having a left clasp;
a right-side frame component comprising a right temple arm, a right temple tip, and a right eye glass rim having a right clasp; and
a nose-bridge component comprising slits on both sides.
   wherein the slits and clasps are configured to allow the clasps to:
mechanically or magnetically attach to the nose bridge component when clasps are pushed into the respective slits; and
release from the nose bridge component when attached clasps are pressed and/or pulled outwards.

### FIELD OF THE INVENTION

The invention relates to the field of prescription eyewear having detachable frame that can be used to access one eye at a time.

### BACKGROUND OF THE INVENTION

Corrective glasses have become more common in recent years to help with eyesight conditions.

Many are unable, or do not wish to correct eyesight with contact lenses which have the advantage of giving more accessibility to the eyes. Traditional prescription eyewear frames do not allow access to the eyes while wearing the glasses. Thus, visually impaired persons have to struggle with corrective solutions in order to access or work around the eye area. This can be quite inconvenient if one needs to access the eye directly but simultaneously requires a prescription lens to see the eye or other surrounding areas.

In particular, makeup wearers requiring corrective/prescription lenses often have difficulty in applying makeup to the eyes due to poor vision and/or, if using corrective lenses in traditional eyewear, due to lack of access to the eye. Many require a magnifying mirror or simply must be at an uncomfortable distance from a mirror to be able to see without prescriptive lenses and be able to access their eyes and eye area for makeup or other related needs.

Similarly, some activities require direct contact of one eye with a device while otherwise maintaining vision, such as examining specimen under a microscope.

### SUMMARY OF THE INVENTION

There are many occasions when a person requiring prescriptive eyewear would like to access the eyes but removal of the glasses then means they cannot see clearly. An individual who cannot or will not correct eyesight with contact lenses is thus left struggling to find a solution.

An object of this invention is to allow users to have full access to one eye and its surrounding area while using the prescriptive lens of the other eye to see properly.

Eye frames for prescriptive lenses comprised of a nose bridge component that can be disconnected easily from either side of the frame are provided. The nose bridge connected to one side of the frame can stay balanced on the face. This allows the user to have full access to one eye and can use the corrective lens from the other eye to see. The invention works both as a prescriptive eyewear and a tool to access one eye at a time.

The present invention provides a detachable three-piece eyeglass frame comprising:
a left-side frame component comprising a left temple arm, a left temple tip, and a left eye glass rim having a left clasp;
a right-side frame component comprising a right temple arm, a right temple tip, and a right eye glass rim having a right clasp; and
a nose-bridge component comprising slits on both sides,
   wherein the slits and clasps are configured to allow the clasps to:
mechanically or magnetically attach to the nose bridge component when clasps are pushed into the respective slits; and
release from the nose bridge component when attached clasps are pressed and/or pulled outwards.

The eyewear is useful in the beauty and cosmetics industry, research laboratory, forensic laboratory, amongst others.

### BRIEF DESCRIPTION OF THE DRAWING

FIG. 1 shows a side view of detached left and right frame components of a three-piece eyeglass frame of the invention.

FIG. 2 shows the top view of temple arms and temple tips of the left and right frame components of a three-piece eyeglass frame of the invention.

FIG. 3 shows the front view of the detached left and right frame components of a three-piece eyeglass frame of the invention including the location and operation of the clasps on the rims.

FIG. 4 shows the front view of the fully attached three-piece eyeglass frame including the nose-bridge component.

FIG. 5 shows detailed views of the nose-bridge component, including front and back view, nose-pads, and a detailed view showing slits at 1:1 scale.

FIG. 6 shows the top view of the fully attached/assembled three-piece eyeglass frame.

### DETAILED DESCRIPTION

The following description is presented to enable a person of ordinary skill in the art to make and use the embodiments of the disclosure. The following detailed description is exemplary in nature and not intended to limit the disclosure or the application and its uses of the embodiments of the disclosure. Modifications to the examples described herein will be readily apparent to those of ordinary skill in the art, and the general principles defined herein may be applied to other examples and applications without departing from the spirit and scope of the disclosure.

Embodiments of the disclosure are described herein in the context of one practical non-limiting application, namely, an easily attachable/detachable frame. Embodiments of the disclosure, however, are not limited to these applications, and the techniques described herein may also be utilized in other applications. For example, embodiments may be applicable to, for example but without limitation, industrial viewing applications, military viewing applications, and the like.

The invention provides mechanisms to easily detach one side of the frame from the nose bridge component while the other side can stay balanced on the face while detached.

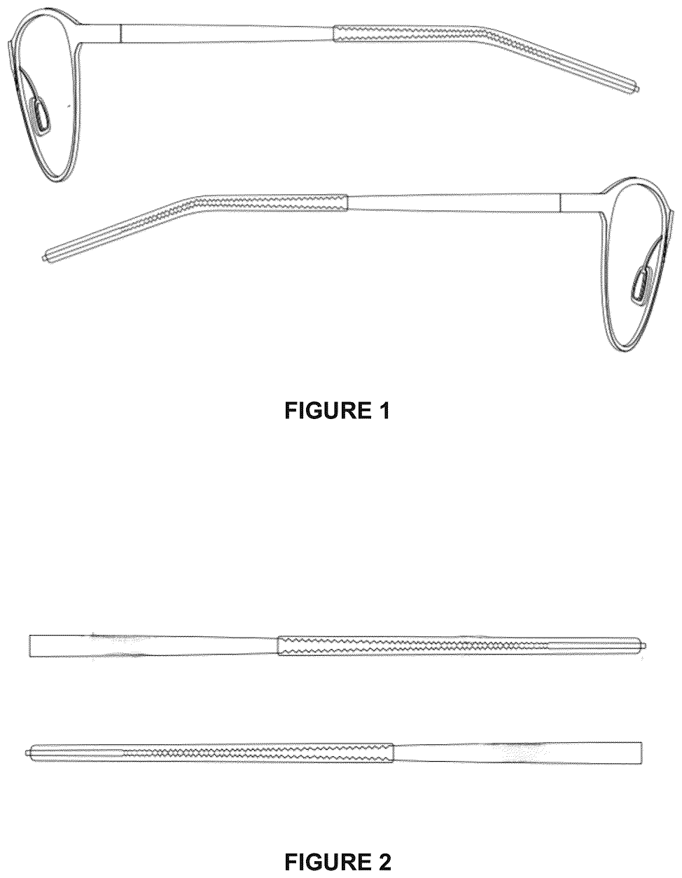

FIGS. 1-6 show embodiments of the inventions and their components.

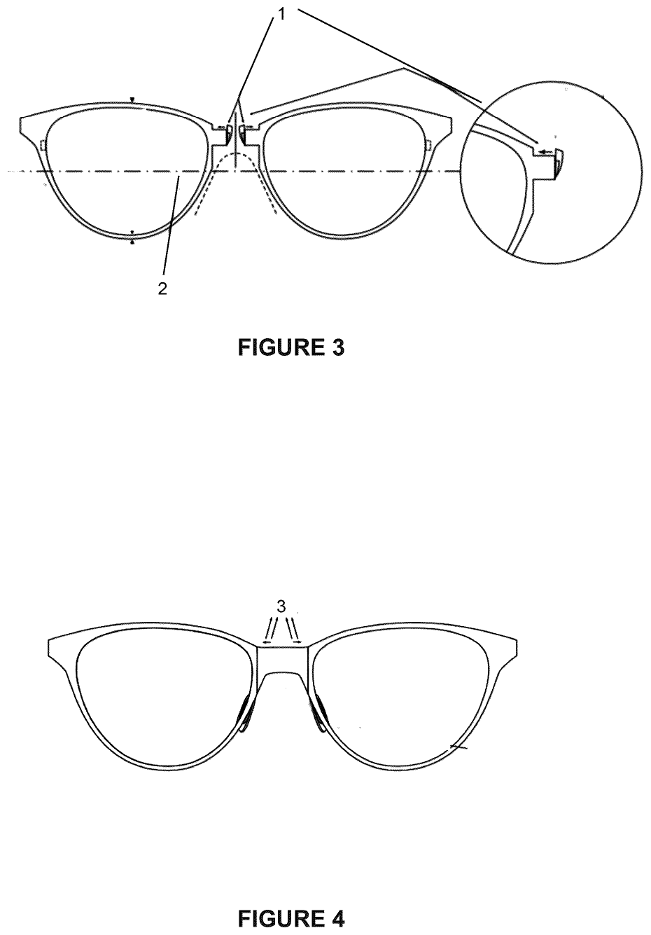

FIG. 3 shows the front view of the detached left and right frame components of a three-piece eyeglass frame of the invention including the location and operation of the clasps on the rims, where 1 denotes push to release clasps, and horizontal line 2 shows location of the center of nosepads with respect to the rims and the frame.

FIG. 4 shows the front view of the fully attached three-piece eyeglass frame including the nose-bridge component and the arrows denoted by 3 show how the left and right side frame components are removed from the nose bridge component by using the clasps.

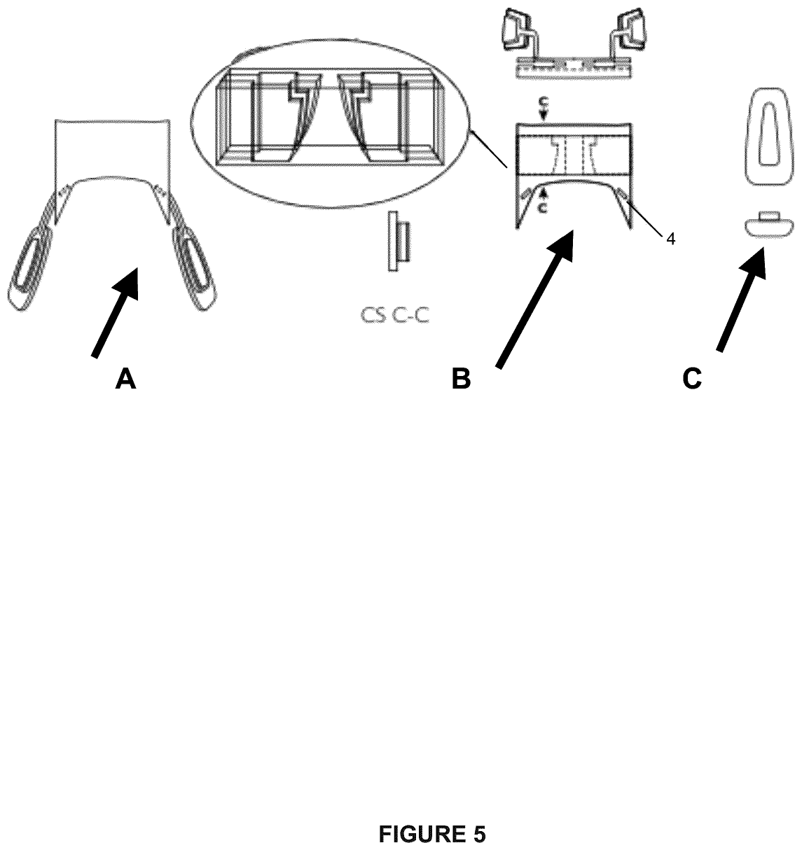

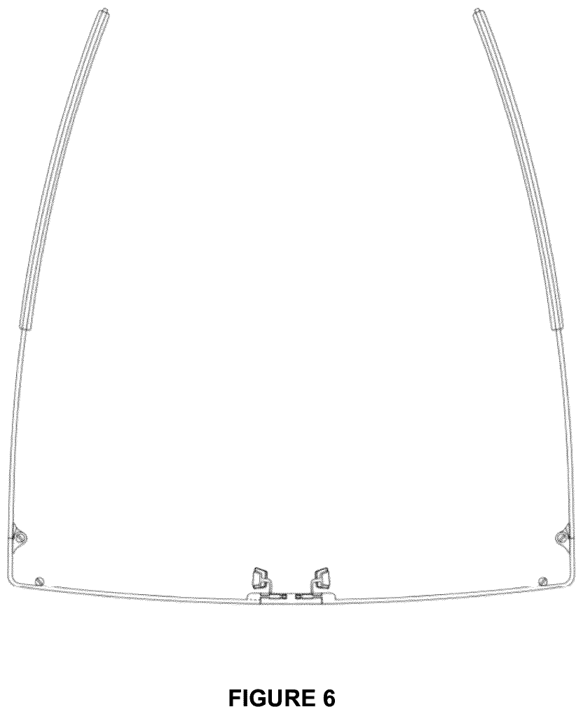

FIG. 5 shows detailed views of the nose-bridge component, including front view A; back view B showing nose pads 4; view of nose-pads C; and a detailed view showing slits at 1:1 scale.

Left/Right Frame Component

The frame component comprises a temple arm, a temple tip, and an eye glass rim having a clasp.

The rims of the frame components hold the prescription lenses.

In some embodiments, the rims may be attached to the temple arms standard (or barrel) hinges, spring (or flex) hinges, or frame may be hingeless. These variations in eyeglasses and their method of preparation are well known in the art.

The frame components can be attached to the nose bridge component through the clasp on the frame component. The clasps are attached to the rims and can be inserted into the nose bridge section component.

The temple arms are connected to the rims on one end and extend to form angled temple tips at the other end. The angled temple tip(s) sit securely on the ear(s) and provide stability to the glass frame.

The temple arms and temple tips are designed to anchor the frame such that the eyewear sits on the face in a balanced manner even if one side of the frame is removed. These may comprise materials that provide a strong grip, such as rubber, cellulose acetate, silicone, or combinations thereof.

Nose Bridge Component

The nose bridge component is an independent piece that has slits on both sides for the clasp(s) to be inserted into, such that the clasp(s) sit securely in the nose bridge, and the rim(s) of the left/right frame component(s) are connected to the nose bridge.

The special clasps allow either side of the frame to be disconnected and removed from the nose bridge component. Each side of the frame has a clasp attached to the rim. The nose bridge component has a slit on both sides where the clasps sit inside securely and tightly.

The slits and clasps are configured to allow the clasps to mechanically and/or magnetically attach to the nose bridge component when clasps are pushed into the respective slits and release from the nose bridge component when attached clasps are pressed and/or pulled outwards.

The clasps may be mechanical and release from the nose bridge component when pressed. To insert, the clasp is pushed into the nose bridge slit.

The clasps may be magnetic and release from the nose bridge component when pulled out of the slot where they sit in the nose bridge component. To insert, the clasp is pushed into the nose bridge slit.

The claps and the nose bridge component may be composed of the same material as the frame components. Suitable materials include light, strong and durable metals, such as titanium.

The clasps can be inserted in different locations on the nose bridge component, such as the top, bottom, side, or inside nose bridge, and the slits on the nose bridge component may be located accordingly.

In some embodiments, clasp that allows either side of the frame to be disconnected and removed from the nose bridge component using magnets are provided.

In some embodiments, the clasps of the frame components and the nose bridge component each have magnetic strips that magnetize and hold together upon contact, wherein the magnetic strips are located where the frame clasps meet the nose bridge.

In some embodiments, the nose bridge component may include nose pads to be attached to a part of it to add stability to the eyeglass frame to allow one or both left/right frame components to sit securely on the face.

In some embodiments, the nose bridge component may be composed of materials that provide added grip, thereby eliminating the need of nose pad arms and nose pads. For example, the nose bridge component may be composed fully or partially of rubber, cellulose acetate, silicone, or combinations thereof. Here, the entire nose bridge component in itself acts like nose pads.

The nose pads, the temple arms and/or temple tips are designed to anchor the frame such that the eyewear sits on the face in a balanced manner even if one side of the frame is removed.

In some embodiments, materials that provide a strong grip such as rubber, cellulose acetate, silicone, or combinations thereof may be included in the nose pads, temple arms and/or temple tips, such as in or on portions of nose pads, temple arms and/or temple tips that are intended to be in contact with the face.

In some embodiments, the entire three-piece eyeglass frame is made of platinum metal. In other embodiments, the entire three-piece eyeglass frame is made of rubber, cellulose acetate, silicone, or combinations thereof. In some other embodiments, other materials, well known in the art for making glass frames, including natural and synthetic materials, may be used for making the entire three-piece eyeglass frame.

In yet other embodiments, some parts of the three-piece eyeglass frame are made of one material and other parts are made of one or more other materials.

In other embodiments, some or all parts of the three-piece eyeglass frame are made of platinum metal and then coated partially, selectively, or fully with one or more of other materials, such as rubber, cellulose acetate, silicone, or combinations thereof.

In some embodiments, some or all parts of the three-piece eyeglass frame are made of cellulose acetate and then coated partially, selectively, or fully with one or more of other materials, such as rubber, silicone, or combinations thereof.

The three-piece eyeglass frames of the present invention may be manufactured by methods well known in the art for manufacturing eyeglasses.

The present invention also provides a method of correcting vision during application of cosmetics comprising:
wearing the three-piece eyeglass frame of the present invention fitted with corrective lenses; and
detaching a left-side frame component or the right-side frame component from the nose bridge component as needed.

The present invention also provides a method of correcting vision during examining samples under a microscope comprising:
wearing the three-piece eyeglass frame of the present invention fitted with corrective lenses; and
detaching a left-side frame component or the right-side frame component from the nose bridge component as needed.

1. A detachable three-piece eyeglass frame comprising:
a left-side frame component comprising a left temple arm, a left temple tip, and a left eye glass rim having a left clasp;
a right-side frame component comprising a right temple arm, a right temple tip, and a right eye glass rim having a right clasp; and
a nose-bridge component comprising slits on both sides,
wherein the slits and clasps are configured to allow the clasps to:
mechanically or magnetically attach to the nose bridge component when clasps are pushed into the respective slits; and
release from the nose bridge component when attached clasps are pressed and/or pulled outwards.

2. The eyeglass frame according to claim 1, wherein the slits and clasps are configured to allow the clasps to:
mechanically attach to the nose bridge component when clasps are pushed into the respective slits; and
release from the nose bridge component when attached clasps are pressed outwards.

3. The eyeglass frame according to claim 1, wherein the slits and clasps are configured to allow the clasps to:
magnetically attach to the nose bridge component when clasps are pushed into the respective slits; and
release from the nose bridge component when attached clasps are pulled outwards.

4. The eyeglass frame according to claim 1, wherein the slits and clasps are configured to allow the clasps to:
mechanically and magnetically attach to the nose bridge component when clasps are pushed into the respective slits; and
release from the nose bridge component when attached clasps are pressed outwards.

5. The eyeglass frame according to claim 1, wherein the nose bridge component comprises nose pads.

6. The eyeglass frame according to claim 3, wherein the clasps of the frame components and the nose bridge component each have magnetic strips that magnetize and hold together upon contact, wherein the magnetic strips are located where the frame clasps meet the nose bridge.

7. The eyeglass frame according to claim 1, wherein the three-piece eyeglass frame is comprised of titanium metal.

8. The eyeglass frame according to claim 5, wherein the nose pad is comprised of rubber, cellulose acetate, silicone, or combinations thereof.

9. The eyeglass frame according to claim 1, wherein the temple arm, temple tip and/or nose bridge component is comprised of rubber, cellulose acetate, silicone, or combinations thereof.

10. The eyeglass frame according to claim 1, wherein the rims are fitted with corrective lenses.

11. The eyeglass frame according to claim 1, wherein the three-piece eyeglass frame is comprised of titanium metal and the temple arm, the temple tip, and/or the nose bridge component are partially comprised of rubber, cellulose acetate, silicone, or combinations thereof.

12. The eyeglass frame according to claim 5, wherein the three-piece eyeglass frame is comprised of titanium metal and the temple arm, the temple tip, the nose bridge, and/or the nose pad are partially comprised of rubber, cellulose acetate, silicone, or combinations thereof.

13. The eyeglass frame according to claim 1, wherein the three-piece eyeglass frame is comprised of titanium metal and the temple arm, the temple tip, and/or the nose bridge component are partially coated with rubber, cellulose acetate, silicone, or combinations thereof.

14. The eyeglass frame according to claim 5, wherein the three-piece eyeglass frame is comprised of titanium metal and the temple arm, the temple tip, the nose bridge, and/or the nose pad are partially coated with rubber, cellulose acetate, silicone, or combinations thereof.

15. The eyeglass frame according to claim 1, wherein the three-piece eyeglass frame is comprised of cellulose acetate and the temple arm, the temple tip, and/or the nose bridge component are partially comprised of rubber, silicone, or combinations thereof.

16. The eyeglass frame according to claim 5, wherein the three-piece eyeglass frame is comprised of cellulose acetate and the temple arm, the temple tip, the nose bridge, and/or the nose pad are partially comprised of rubber, silicone, or combinations thereof.

17. The eyeglass frame according to claim 1, wherein the three-piece eyeglass frame is comprised of cellulose acetate and the temple arm, the temple tip, and/or the nose bridge component are partially coated with rubber, silicone, or combinations thereof.

18. The eyeglass frame according to claim 5, wherein the three-piece eyeglass frame is comprised of cellulose acetate and the temple arm, the temple tip, the nose bridge, and/or the nose pad are partially coated with rubber, silicone, or combinations thereof.

19. A method of correcting vision during application of cosmetics comprising:
wearing the three-piece eyeglass frame of claim 1 fitted with corrective lenses; and
detaching a left-side frame component or the right-side frame component from the nose bridge component as needed.

20. A method of correcting vision during examining samples under a microscope comprising:
wearing the three-piece eyeglass frame of claim 1 fitted with corrective lenses; and
detaching a left-side frame component or the right-side frame component from the nose bridge component as needed.
